(19) United States
(12) Patent Application Publication
(10) Pub. No.: US 2021/0342788 A1
(43) Pub. Date: Nov. 4, 2021

(54) ELECTRONIC MATCHING FOR A HEARING

(71) Applicant: WebRam LLC, Houston, TX (US)

(72) Inventors: Heriberto Ricardo Ramos, Houston, TX (US); Randall Keith Weber, JR., Houston, TX (US)

(21) Appl. No.: 16/862,233

(22) Filed: Apr. 29, 2020

(51) Int. Cl. G06Q 10/10; G06F 16/9535; G06Q 30/00; G06Q 50/18

(52) U.S. Cl. CPC G06Q 10/1095; G06F 16/9535; G06F 3/0482; G06Q 30/0185; G06Q 50/18; G06Q 10/1097

(57) ABSTRACT

A computer-implemented method may be performed by computing device interacting with first and second remote computing devices, to perform electronic matching for a hearing. The method includes receiving, from the first computing device, a request for an attorney to cover a hearing, which may include availability requirements and attorney qualifications for the hearing. The method includes notifying the second computing device of the request. The method may further include receiving from the second computing device an indication of availability of a first attorney of interest and a match request for the hearing and determining qualifications for the first attorney of interest. Upon determining that the availability and the qualifications of the first attorney of interest match the availability requirements and attorney qualifications of the hearing, respectively, the method may include communicating a response, to the first computing device, that identifies the first attorney of interest to cover the hearing.

### BACKGROUND

A hearing, such as an administrative or court hearing, may be used to resolve disputes, for instance between citizens/subjects or between a citizen/subjects and an agency or state. In a hearing, evidence and/or arguments may be presented to a presiding officer, such as a judge. Moreover, representatives, such as an attorney representing the citizen/subject, may attend or “cover” the hearing to present the evidence and/or arguments.

### BRIEF DESCRIPTION OF THE DRAWINGS

The present disclosure may be better understood from the following detailed description when read with the accompanying figures. It is emphasized that, in accordance with standard practice in the industry, various features are not drawn to scale. In fact, the dimensions or locations of functional attributes may be relocated or combined based on design, security, performance, or other factors known in the art of computer systems. Further, order of processing may be altered for some functions, both internally and with respect to each other. That is, some functions may not require serial processing and therefore may be performed in an order different than shown or possibly in parallel with each other. For a detailed description of various examples, reference be made below to the accompanying drawings, in which:

FIGS. 1A-1B illustrate a first example method of operation (e.g., a process flow) for a computing device, according to one or more disclosed implementations;

FIG. 2 illustrates a second example method of operation (e.g., a process flow) for a computing device, according to one or more disclosed implementations;

FIG. 3 illustrates a third example method of operation (e.g., a process flow) for a computing device, according to one or more disclosed implementations;

FIG. 4 illustrates a first example computing device (e.g., a machine-readable storage medium) including executable computer instructions that may be used to implement different aspects of electronic matching for a hearing, according to one or more disclosed implementations;

FIG. 5 illustrates a second example computing device (e.g., a processor, a GUI, a location device, and a machine-readable storage medium) including executable computer instructions that may be used to implement different aspects of electronic matching for a hearing, according to one or more disclosed implementations; and

FIG. 6 illustrates a third example computing device and components thereof that may work collectively to provide functionality of a specifically configured capability to implement methods, and other techniques of this disclosure, of electronic matching for a hearing, according to one or more disclosed implementations.

### DETAILED DESCRIPTION

Illustrative examples of the subject matter claimed below will now be disclosed. In the interest of clarity, not all features of an actual implementation are described for every example implementation in this specification. It will be appreciated that in the development of any such actual example, numerous implementation-specific decisions may be made to achieve the developer's specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

A hearing may be scheduled and information regarding the hearing, such as a date, location, time, presiding judge, courtroom, a law firm or lawyer, etc., may be documented for the hearing. Moreover, an attorney who is scheduled to cover the hearing may have a conflict. In some instances, the conflict may result in rescheduling a hearing, which may result in a waste of time. In some cases, such as criminal and immigration cases, the conflict may result in a criminal defendant or detainee spending more time than desired in a detention center.

The disclosed examples may be beneficial to implement processes and computing devices for electronic matching for a hearing to efficiently suggest and determine a replacement attorney for the hearing. Efficiency may be enhanced, in some examples, by synchronizing with electronic calendars to determine availability for a particular attorney and/or accessing an electronic court docketing system to modify an attorney covering a hearing.

An example computer-implemented method may be performed by computing device, such as a server, interacting with a first computing device (e.g., a first client device) and a second computing device (e.g., a second client device), to perform electronic matching for a hearing. The method includes receiving, from the first computing device, a request for an attorney to cover a hearing, which may include availability requirements and attorney qualifications for the hearing. The method includes notifying the second computing device of the request. The method may further include receiving from the second computing device an indication of availability of a first attorney of interest and a match request for the hearing and determining qualifications for the first attorney of interest. Upon determining that the availability and the qualifications of the first attorney of interest match the availability requirements and attorney qualifications of the hearing, respectively, the method may include communicating a response, to the first computing device, that identifies the first attorney of interest to cover the hearing.

Having the above overview, we turn to the FIGs. to provide more detail and explain some example operational environments where the methods of operation and computing devices for implementing electronic matching for a hearing may be beneficial. Other types of situations are also possible and within the scope of this disclosure.

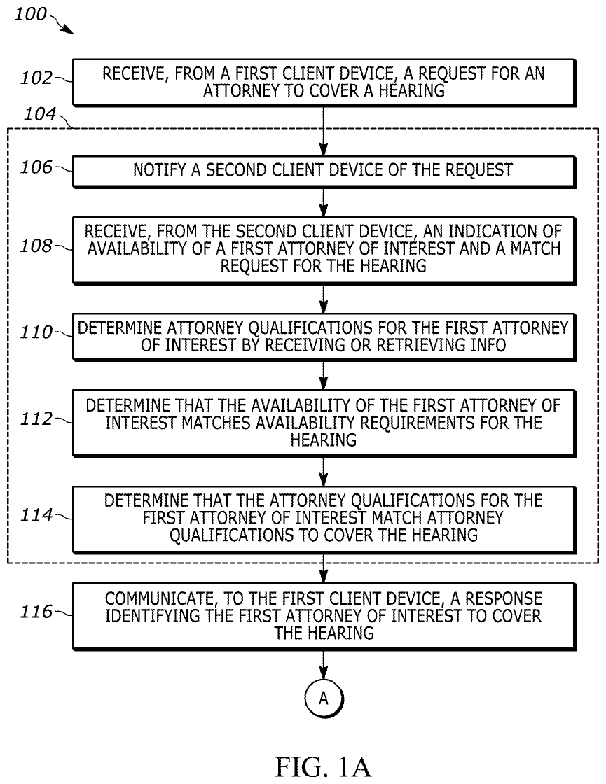

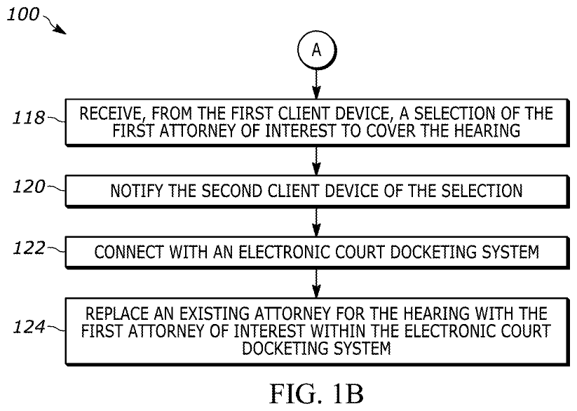

Referring now to the drawings, FIGS. 1A-1B, combined, are a flow chart depicting an example method 100 of performing a processing flow to implement electronic matching for a hearing, such as a legal court hearing or a tribunal holding some other government agency hearing. In the following described example, a server device implements the method 100 while communicating with a plurality of client devices. Herein, both server devices and client devices are referred to generally as computing devices. However, as part of its functionality, a client device may execute an application or “app” to facilitate electronic matching for a hearing, in accordance with the present teachings. In a specific example, the app presents a graphical user interface (“GUI”) on a display of the client device to facilitate electronic matching for a hearing. Examples of a client device include, but are not limited to, a smartphone, a personal computer, a tablet, etc.

In another example, e.g., in a serverless environment, a first client device implements method 100 while communicating with a second remote client device. For instance, the first client device may include a processor that executes instructions stored on a machine-readable storage medium to implement the method 100. The executable instructions may include instructions that present a GUI on a display of the first client device and may include further instructions allowing the first client device to communicate with the second remote client device.

Turning now to method 100 as implemented by a server device, at block 102 the server device receives a request for an attorney to cover a hearing. The request is received from a first client device. For example, an app executing on the first client device presents a GUI on a display of the first client device. The GUI allows a user of the first client device to interact with graphics, such as icons, buttons, screens, and windows to request attorney coverage for a particular hearing.

For example, the GUI may prompt the user to enter and/or select (for instance from a dropdown menu) availability requirements for the hearing for which coverage is requested. The availability requirements for the hearing may include a date, a location, and a time of the hearing. A location of the hearing may include information such as an address, a courthouse, a courtroom, etc. The GUI may prompt the user to enter additional information for the hearing, such as a presiding judge. In another example, the app synchronizes or otherwise interacts with an electronic calendar and/or an electronic docket to retrieve some or all of the availability requirements for the hearing. The electronic calendar and/or electronic docket may be executing on the first client device or otherwise accessible by the first client device from another computing device.

The GUI may further prompt the user of the first client device to enter or select attorney qualifications to cover the hearing. The attorney qualifications can include, but are not limited to, type of practice (such as criminal, family, immigration, bankruptcy, etc.), years of time in practice, whether the attorney has experience practicing before a particular judge, etc. Upon receiving the availability requirements and the attorney qualifications for the hearing, the app executing on the first client device may create a request having and/or indicating the availability requirements and the attorney qualifications. The first client device sends the request to the server device. The request can take any suitable format to alert the server device to perform processing to implement electronic matching for the hearing. The electronic matching process allows the server device to respond to the request by identifying an attorney to cover the hearing.

For example, upon receiving the request, the server device performs processing indicated in dashed block 104, which includes blocks 106-114, to implement the electronic matching to determine an attorney to cover the hearing. Performing the processing indicated in dashed block 104 includes communicating with a second client device. Thereafter, at block 116, the server device communicates, to the first client device, a response identifying a first attorney of interest to cover the hearing. The server device may perform the processing indicated in dashed block 104 multiple times and communicate with multiple client devices to determine and identify to the first client device, at block 116, multiple attorneys that may cover the hearing.

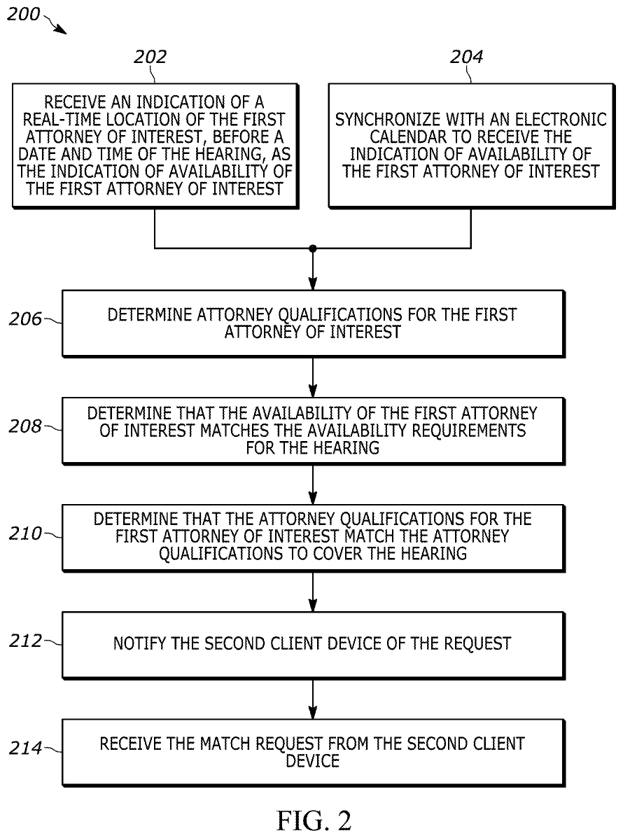

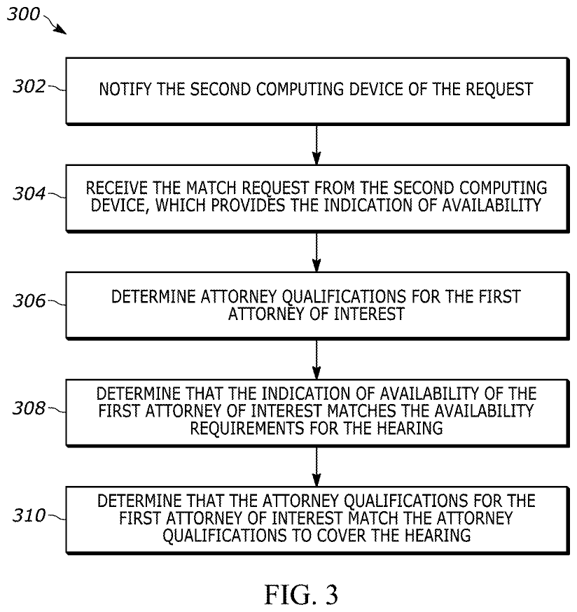

The server device may implement block 104 by performing some or all of the processing indicated in blocks 106-114 in different orders. For example, FIGS. 2 and 3 illustrate two different implementations of performing some or all of the processing indicated in blocks 106-114 of dashed block 104. However, following is a general description of the processing indicated in blocks 106-114.

At block 106, the server device notifies a second client device of the request for an attorney to cover the hearing. In an example, the server device notifies the second client device of the request by communicating to the second client device the availability requirements for the hearing and the attorney qualifications to cover the hearing. An app executing on the second client device may present the request by presenting the availability requirements for the hearing and the attorney qualifications to cover the hearing. For example, the app executing on the second client device may present a GUI on a display of the second client device. The GUI allows a user of the second client device to interact with graphics, such as icons, buttons, screens, and windows to view the request for an attorney to cover hearing. In a particular example, the GUI presents the availability requirements (e.g., date, location, and time) for the hearing and the attorney qualifications (e.g., type and number of years of practice) to cover the hearing.

At block 108, the server device may receive, from the second client device, an indication of availability of a first attorney of interest and a match request for the hearing. The match request for the hearing, which may take any suitable format, notifies the server device to continue the electronic matching for the hearing based on availability of the first attorney of interest. For example, the match request prompts the server device to continue the processing indicated in blocks 110-114.

In one example, receiving the indication of availability includes receiving an indication of a real-time location of the first attorney of interest. For instance, the real-time location of the first attorney of interest may correspond to a current location of the second client device when the user of the second client device is the first attorney of interest. The location of the second client device may be determined by a location device, e.g., a Global Positioning System (“GPS) chip, within the second client device and communicated from the second client device to the server device. In another example, the server device synchronizes with an electronic calendar to receive the indication of availability of the first attorney of interest. For instance, the server device may have stored credentials for accessing an electronic calendar of the first attorney of interest to determine the availability of the first attorney of interest. In yet another example, the match request itself is a confirmation of availability and thereby provides the indication of availability of the first attorney of interest.

At block 110, the server device determines the attorney qualifications for the first attorney of interest. For example, the server device determines the attorney qualifications for the first attorney of interest by retrieving the attorney qualifications for the first attorney of interest from a data structure residing on a storage device, such as a database. In one specific example, the first attorney of interest may have previously provided his or her attorney qualifications to a service provider that hosts the app executing on the second client device. The attorney qualifications for the first attorney of interest may be stored in a database remote to the second client device and accessible by the server device. The server device may, thereby, retrieve the attorney qualifications for the first attorney of interest from the database.

In another example, the server device determines the attorney qualifications for the first attorney of interest by receiving the attorney qualifications from the second computing device. In one specific example, the database that stores the qualifications of the first attorney of interest is accessible to the second client device but not the server device. Accordingly, the second client device may retrieve the attorney qualifications of the first attorney of interest and send them to the server device when sending the match request. In another specific example, the first attorney of interest may enter and/or select his or her qualifications using the GUI executing on the second client device, which the second client device may send to the server device when sending the match request.

Based on the indication of availability, the server device may compare the availability of the first attorney of interest with the availability requirements for the hearing. For instance, the server device may compare calendar availability of the first attorney of interest to the date and time of the hearing. Alternatively, the match request may indicate that the first attorney of interest has availability during the time and date of the hearing. Accordingly, at block 112, the server device determines that the availability of the first attorney of interest matches the availability requirements for the hearing. In other words, the server device determines that the first attorney of interest has availability to cover the hearing.

The server device may also compare the attorney qualifications of the first attorney of interest with the attorney qualifications for or to cover the hearing. In one example, the attorney qualifications for the hearing include at least five years of experience in criminal law. In this case, the qualifications serve as minimum qualifications to cover the hearing. In a further example, the qualifications for the first attorney of interest include ten years of experience in criminal law, and twenty years of experience as a trial attorney. Accordingly, at block 114, the server device may determine that the attorney qualifications for the first attorney of interest match the attorney qualifications to cover the hearing. A “match” in the attorney qualifications in this example means that the attorney qualifications for a particular attorney at least meet the minimum qualifications to cover the hearing.

In the above example, the attorney qualifications of the first attorney of interest at least met the minimum qualifications of five years of experience in criminal law, even though the experience of the first attorney of interest exceeded this minimal amount of experience. In other examples, the attorney qualifications to cover the hearing may serve as maximum qualifications to cover the hearing. For instance, the attorney qualifications for the hearing may include no more than five years of experience in criminal law. In this case, to determine a match in block 114, the first attorney of interest would need five years or less of experience in criminal law. In other examples, the attorney qualifications to cover the hearing may require an exact match between the qualifications of the first attorney of interest and the qualifications for the hearing. As mentioned above, when both the availability and qualifications of the first attorney of interest match, respectively, the availability requirements and attorney qualifications for the hearing, the server device may, at block 116, communicate to the first client device a response identifying the first attorney of interest to cover the hearing.

At block 118, the server device may receive, from the first client device, a selection of the first attorney of interest to cover the hearing. In an example, the selection of the first client device may be from among multiple attorneys identified by the server device to the first client device in block 116. The multiple attorneys may have different qualifications and/or availability. For instance, the first attorney of interest may have trial experience that the other attorneys don't have, or the first attorney of interest may be available for a larger block of time that includes the availability requirements of the present hearing and availability requirements of a second hearing for which coverage is sought.

At block 120, the server device notifies the second computing device of the selection. In an example, the app executing on the second client device presents the selection of the first attorney of interest through the GUI presented on the display of the second client device. In a particular example, when the availability of the first attorney of interest is based on the real-time location of the second client device, the server device may notify the second client device on the day of the hearing but before the time of the hearing. In an alternative example where the server device accesses an electronic calendar to obtain the availability of the first attorney of interest, the server device may access the electronic calendar to place at least the date, time, and location of the hearing on the electronic calendar.

In one particular scenario, an electronic court docketing system may maintain information about the hearing, including the date, time, location (e.g., courtroom), judge, information regarding an attorney covering the hearing, etc. In this scenario, the server device may have access to the electronic court docketing system to edit at least the information regarding an attorney covering the hearing. Accordingly, at block 122, the server device connects with the electronic court docking system. This may include accessing the electronic court docking system using credential provided to an administrator of the server device, credentials provided to a law firm, or credentials provided to an individual attorney. At block 124, the server device may then replace an existing attorney for the hearing with the first attorney of interest within the electronic court docketing system.

FIG. 2 is a flow chart depicting an example method 200 of performing a processing flow to implement electronic matching for a hearing, according to the present teachings. Particularly, FIG. 2 illustrates one example implementation of performing the processing indicated in blocks 106-114 of dashed block 104 of method 100. As described below, the server device implements method 200 while communicating with the second client device. However in an alternative example, the first client device implements method 200 while communicating with the second client device.

In the example method 200, an indication of availability of the first attorney of interest to cover the hearing is received before notifying the second client device of the request for an attorney to cover the hearing. Accordingly, at block 202 or at block 204, the server device receives an indication of availability of the first attorney of interest.

Particularly, at block 202, the server device receives an indication of a real-time location of the first attorney of interest (e.g., GPS coordinates of the second client device). For example, the server device receives the real-time location of the first attorney of interest on the date of the hearing but before the time of the hearing. In a particular example, the first attorney of interest is using the second client device near a courthouse and opens an app that monitors for requests for an attorney to cover a hearing. In this example, the second client device may send to the server device one or more indications of a real-time location of the second client device. The indication of the real-time location may be GPS coordinates of the second client device, which indicate the location of the first attorney of interest.

Alternatively, at block 204, the server device synchronizes with an electronic calendar to receive the indication of availability of the first attorney of interest. Such synchronization may be performed similar to that described above by reference to block 108 of method 100. In a particular example, the first attorney of interest may have the app open and use the GUI presented on the display of the second client device to request synchronization with an electronic calendar. The request for synchronization allows the server device to retrieve or receive the availability of the first attorney of interest for electronic matching for a hearing.

At block 206, the server device determines attorney qualifications for the first attorney of interest. For example, the server device may retrieve the attorney qualifications from a database or receive the attorney qualifications from the second client device. Where the server device determines at blocks 208 and 210, respectively, that the availability of the first attorney of interest matches the availability requirements of the hearing and the attorney qualifications of the first attorney of interest match the attorney qualifications to cover the hearing, the server device notifies the second client device of the request for an attorney to cover the hearing, at block 212.

At block 214, the server device receives a match request from the second client device. The match request may be received in response to a selection by the first attorney of interest using a GUI presented on a display of the second client device. Responsive to receiving the match request, the server device may communicate to the first client device a response that identifies the first attorney of interest to cover the hearing, for example as described by reference to block 116 of method 100.

FIG. 3 is a flow chart depicting an example method 300 of performing a processing flow to implement electronic matching for a hearing, according to the present teachings. Particularly, FIG. 3 illustrates another example implementation of performing the processing indicated in blocks 106-114 of dashed block 104 of method 100. As described below, the server device implements method 300 while communicating with the second client device. However in an alternative example, the first client device implements method 300 while communicating with the second client device.

In the example method 300, an indication of availability of the first attorney of interest to cover the hearing is received after notifying the second client device of the request for an attorney to cover the hearing. Accordingly, at block 302, the server device may notify the second client device of the request for an attorney to cover the hearing.

In a particular example, the first attorney of interest may have an app open on the second client device that presents via a GUI multiple requests for an attorney to cover a hearing. The first attorney of interest may select one or more requests, for which the first attorney of interest has availability to cover. Responsive to each request selected, the app may construct and send a match request to the server device. At block 304, the server device receives the match request from the second client device. In this example, since the first attorney of interest presumably only selects requests for which she has availability, the match request provided the indication of availability of the first attorney of interest.

At block 306, the server device determines attorney qualifications for the first attorney of interest. For example, the server device may retrieve the attorney qualifications from a database or receive the attorney qualifications from the second client device. The server device may determine at blocks 308 and 310, respectively, that the availability of the first attorney of interest matches the availability requirements of the hearing and the attorney qualifications of the first attorney of interest match the attorney qualifications to cover the hearing. Upon reaching such determinations, the server device may communicate to the first client device a response that identifies the first attorney of interest to cover the hearing, for example as described by reference to block 116 of method 100.

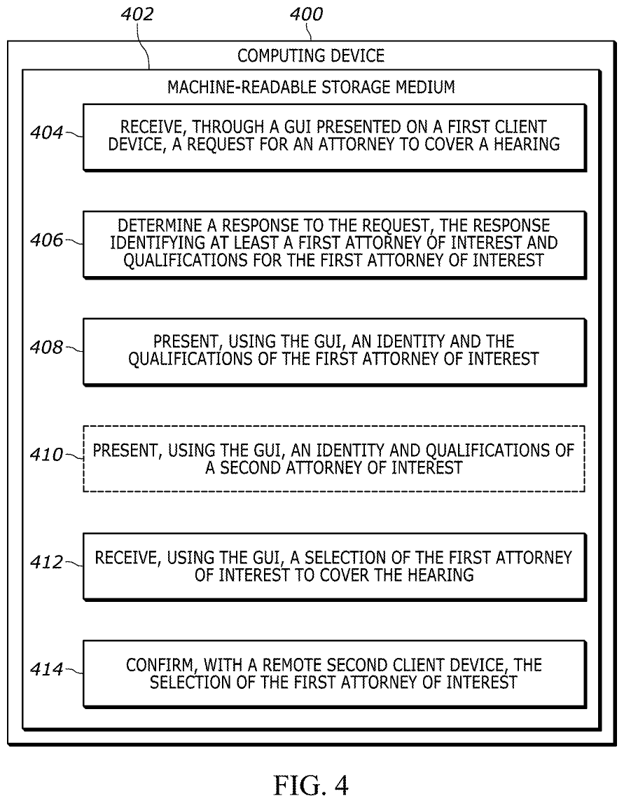

Referring now to FIG. 4, shown is an example computing device 400 with machine-readable instructions 404-414 stored on a machine-readable storage medium 402 that may be used to implement electronic matching for a hearing, according to one or more disclosed example implementations. The machine-readable instructions 404-414 may be executed by a processor (not shown) of the computing device 400.

In an example, the computing device 400 may be included within a client device, referred to hereinafter as a first client device 400. In a further example, the machine-readable instructions 404-414 may configure the first client device 400 to perform one or more of the methods 100, 200, or 300, or portions thereof. In a further example, an app may be executed on the first client device 400 using machine-readable instructions, which include the instructions 400-414 and which may be stored in the machine-readable storage medium 402.

A machine-readable storage medium, such as 402 of FIG. 4, may include both volatile and nonvolatile, removable and non-removable media, and may be any electronic, magnetic, optical, or other physical storage device that contains or stores executable instructions, data structures, program module, or other data accessible to a processor, for example firmware, erasable programmable read-only memory (“EPROM”), random access memory (“RAM”), non-volatile random access memory (“NVRAM”), optical disk, solid state drive (“SSD”), flash memory chips, and the like. The machine-readable storage medium may be a non-transitory storage medium, where the term “non-transitory” does not encompass transitory propagating signals.

Referring now to the machine-readable instructions 404-414, machine-readable instruction 404 may cause the first client device 400 (e.g., the processor (not shown) of the first client device 400) to receive a request for an attorney to cover a hearing. For example, an app executing on the first client device 400 may present a GUI on a display (not shown) of the first client device 400. A user may interact with the GUI to request an attorney to cover a hearing, which the processor receives. The request includes availability requirements (e.g. a date, a location, a time, etc.) of the hearing and attorney qualifications to cover the hearing.

Machine-readable instruction 406 may cause the first client device 400 to determine a response to the request. The response identifies at least a first attorney of interest having availability that meets the availability requirements and qualifications that meet the attorney qualifications to cover the hearing. In one example, the machine-readable instruction 406 causes the first client device 400 to perform the processing indicated at blocks 106-114 to determine a response to the request. In another example, the machine-readable instruction 406 causes the first client device 400 to perform the method 200 to determine a response to the request. In yet another example, the machine-readable instruction 406 causes the first client device 400 to perform the method 300 to determine a response to the request.

Machine-readable instruction 408 may cause the first client device 400 to present an identity of the first attorney of interest using the GUI. The identity may include a name of the first attorney of interest. The identity may also include a bar number of the first attorney of interest. Machine-readable instruction 408 may further cause the first client device 400 to present the qualifications of the first attorney of interest using the GUI.

Where the first client device 400 communicates with a plurality of remote client devices to determine a response to the request, machine-readable instruction 406 may cause the first client device 400 to determine a response to the request, which identifies a plurality of attorneys (e.g., a first attorney of interest and a second attorney of interest) having availability and qualifications that, respectively, meet the availability requirements and attorney qualifications to cover the hearing. Accordingly, machine-readable instruction 410 may cause the first client device 400 to present an identity (e.g., a name and bar number) of the second attorney of interest using the GUI. Machine-readable instruction 410 may further cause the first client device 400 to present the qualifications of the second attorney of interest using the GUI.

Presenting the qualifications of attorneys may allow a more informed selection of an attorney to cover the hearing. For example, different experience levels, familiarity with the presiding judge for the hearing, familiarity with the type of hearing, etc. may be factored into the selection.

Machine-readable instruction 412 may cause the first client device 400 (e.g., the processor (not shown) of the first client device 400) to receive, using the GUI, a selection of the first attorney of interest to cover the hearing. For example, the user may interact with the GUI to select the first attorney of interest to cover the hearing. The first attorney of interest may be selected from a plurality of attorneys, including the second attorney of interest, presented using the GUI.

Finally, machine-readable instruction 414 may cause the first client device 400 (e.g., the processor (not shown) of the first client device 400) to confirm, with a remote second client device, the selection of the first attorney of interest. For example, machine-readable instruction 414 may cause the first client device 400 to perform the processing indicated at block 120 of method 100, as described above.

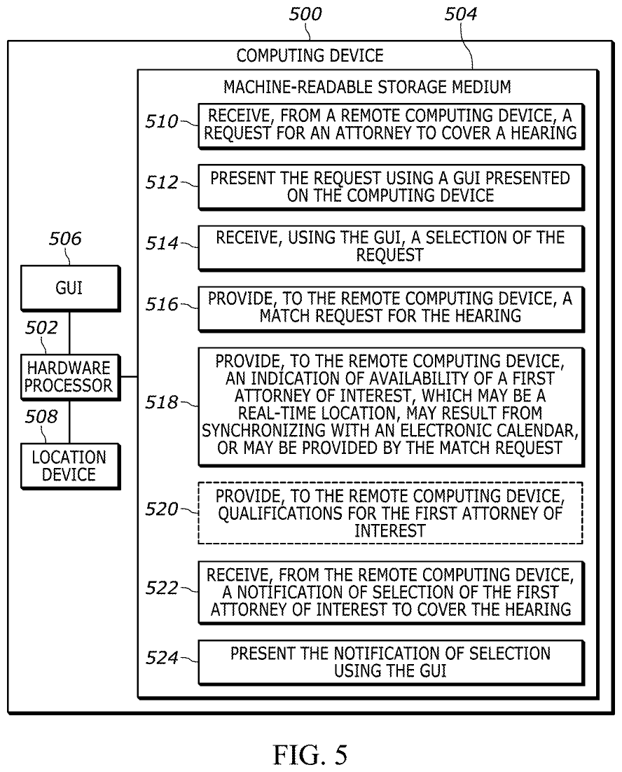

Referring now to FIG. 5, shown is an example computing device 500 with a hardware processor 502, machine-readable instructions 510-524 stored on a machine-readable storage medium 504, and a location device 508 that may be used to implement electronic matching for a hearing, according to one or more disclosed example implementations. The machine-readable instructions 510-524 may be executed by hardware processor 502.

In an example, the computing device 500 may be included within a client device, which may communicate with a remote computing device, such as a server device or a remote client device. In a further example, an app may be executed on the computing device 500 using machine-readable instructions, which include the instructions 510-524 and which may be stored in machine-readable storage medium 504. Certain of the machine-readable instructions 510-524 of the app, may cause the processor to present a GUI 506 on a display (not shown) of the computing device 500, with which a user may interact.

Hardware processor 502, referred to hereinafter as processor 502, may include a single or multiple processor cores. The processing elements that make up processor 502 may also include one or more of other types of hardware processing components, such as graphics processing units (“GPU”), application specific integrated circuits (“ASICs”), field-programmable gate arrays (“FPGAs”), and/or digital signal processors (“DSPs”). Location device 508, such as a GPS chip, may be used to determine the location of computing device 500.

Machine-readable storage medium 504 may include both volatile and nonvolatile, removable and non-removable media, and may be any electronic, magnetic, optical, or other physical storage device that contains or stores executable instructions, data structures, program module, or other data accessible to a processor, for example firmware, erasable programmable read-only memory (“EPROM”), random access memory (“RAM”), non-volatile random access memory (“NVRAM”), optical disk, solid state drive (“SSD”), flash memory chips, and the like. Moreover, machine-readable storage medium 504 may be a non-transitory storage medium.

Referring now to machine-readable instructions 510-524, machine-readable instruction 510 may cause processor 502 to receive, from a remote computing device, a request for an attorney to cover a hearing. The request includes availability requirements (e.g. a date, a location, a time, etc.) of the hearing and attorney qualifications to cover the hearing.

Machine-readable instruction 512 may cause processor 502 to present the request using GUI 506. For example, GUI 506 may show the availability requirements of the hearing and attorney qualifications to cover the hearing on the display (not shown) of computing device 500. A user, e.g., a first attorney of interest, may interact with GUI 506 to select the request, for instance when qualifications of the first attorney of interest match qualifications to cover the hearing. Machine-readable instruction 514 may cause processor 502 to receive the selection of the request using GUI 506.

Machine-readable instructions 516 and 518 may cause processor 502 to respectively provide, to the remote computing device, a match request for the hearing and an indication of availability of the first attorney of interest. Machine-readable instruction 520 may cause processor 502 to optionally provide, to the remote computing device, qualifications of the first attorney of interest, for instance depending a version of the app being used. Receipt of the match request allows the remote computing device to implement processes, such as portions of one or more of methods 100, 200, or 300, to perform electronic matching for a hearing based on the indication of availability of the first attorney of interest. The indication of availability may be a real-time location, may result from synchronizing with an electronic calendar, or may be provided by the match request.

In one implementation scenario, the indication of availability of the first attorney of interest may be provided before receiving the request for an attorney to cover the hearing. In a particular example, the first attorney of interest is using computing device 500 near a courthouse and opens an app that monitors for requests for an attorney to cover a hearing. In this example, machine-readable instruction 518 may cause the computing device 500 to send to the remote computing device one or more indications of a real-time location of computing device 500, as determined by location device 508. The indication of the real-time location may be GPS coordinates of computing device 500, which may indicate the location of the first attorney of interest. The real-time location may be provided on the date but before the time of the hearing.

Alternatively, machine-readable instruction 518 may cause processor 502 to synchronize with an electronic calendar. The electronic calendar may also be executing on computing device 500 and may be an electronic calendar for the first attorney of interest. Synchronizing with the electronic calendar allows processor 502 to determine and provide, to the remote computing device, the availability of the first attorney of interest.

In another implementation scenario, the indication of availability of the first attorney of interest is provided after receiving the request for an attorney to cover the hearing. For example, the computing device 500 may receive the request to cover the hearing. In response to receiving the request and in response to receiving a selection of the request, using GUI 506, the computing device 500 may send the match request. The match request itself may provide the indication of availability of the first attorney of interest to the remote computing device.

Returning again to the machine-readable instructions, machine-readable instruction 522 may cause processor 502 to receive, from the remote computing device, a notification of selection of the first attorney of interest to cover the hearing. Machine-readable instruction 524 may cause processor 502 to present the notification of the selection using GUI 506. This presentation may allow the first attorney of interest to be aware of being selected to cover the hearing.

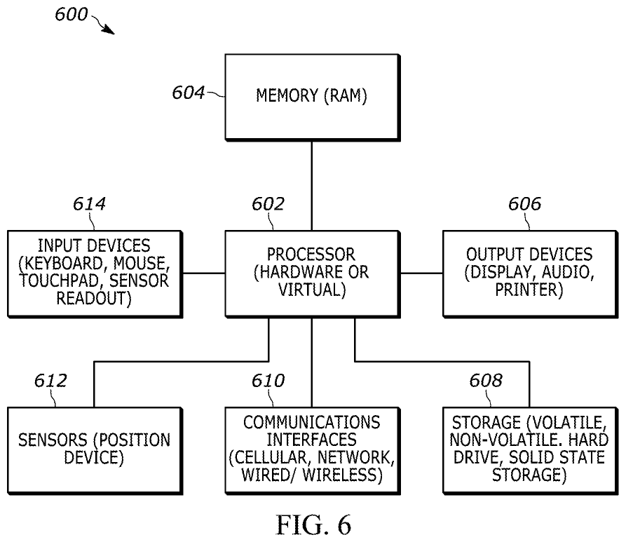

FIG. 6 illustrates an example computing device 600 that may be used to implement or be used with the functions, modules, processing platforms, execution platforms, communication devices, and other methods and processes of this disclosure. For example, computing device 600 illustrated in FIG. 6 could represent a client device or a physical server device. As such, computing device 600 may implement one or more of the methods 100, 200, or 300, or portions thereof and may implement the machine-readable instructions 404-414 of FIG. 4 or 510-524 of FIG. 5, or portions thereof.

Moreover, computing device 600 may include either hardware or virtual processor(s) depending on the level of abstraction of the computing device. In some instances (without abstraction), computing device 600 and its elements, as shown in FIG. 6, each relate to physical hardware. Alternatively, in some instances one, more, or all of the elements could be implemented using emulators or virtual machines as levels of abstraction. In any case, no matter how many levels of abstraction away from the physical hardware, computing device 600 at its lowest level is implemented on physical hardware.

As shown in FIG. 6, computing device 600 includes one or more input devices 614, such as a keyboard, mouse, touchpad, or sensor readout (e.g., biometric scanner) and one or more output devices 606, such as displays, speakers for audio, or printers. Some devices may be configured as combined input/output devices (e.g., a network interface or touchscreen display). A user interface (e.g., output devices 606 and input devices 614) can include a display, positional input device (such as a mouse, touchpad, touchscreen, or the like), keyboard, or other forms of user input and output devices. The user interface components may be communicatively coupled to a processor 602 of the computing device 600. In a particular example, a GUI may be viewed and interacted with using components of the user interface.

Computing device 600 also includes communications interfaces 610, such as a network communication unit that could include a wired communication component and/or a wireless communications component, which may be communicatively coupled to processor 602. The network communication unit may utilize any of a variety of proprietary or standardized network protocols, such as Ethernet, TCP/IP, to name a few of many protocols, to effect communications between devices. Network communication units may also include one or more transceiver(s) that utilize the Ethernet, Bluetooth®, power line communication (“PLC”), WiFi®, cellular, and/or other communication methods. In an example, the communication interfaces 610 may be used to communicate with another computing device. For instance, a request for an attorney to cover a hearing, a match request, notifications, an indication of availability of an attorney, etc., may be sent and/or received using the communication interfaces 610.

As illustrated in FIG. 6, computing device 600 includes a processing element such as processor 602 that contains one or more hardware processors, where each hardware processor may have a single or multiple processor cores. Examples of processors include, but are not limited to, a central processing unit (CPU) and a microprocessor. Although not illustrated in FIG. 6, the processing elements that make up processor 602 may also include one or more of other types of hardware processing components, such as GPUs, ASICs, FPGAs, and/or DSPs.

FIG. 6 further illustrates that computing device 600 includes a memory 604, which may be operatively and communicatively coupled to processor 602. Memory 604 may be a non-transitory medium configured to store various types of data such as machine-readable instructions 404-412 of FIGS. 4 and 510-524 of FIG. 5. For example, memory 604 may include one or more storage devices 608 that include a non-volatile storage device and/or volatile memory. Volatile memory, such as random-access memory (“RAM”), can be any suitable non-permanent storage device. The non-volatile storage devices 608 can include one or more disk drives, optical drives, solid-state drives (“SSDs”), tap drives, flash memory, read only memory (“ROM”), and/or any other type of memory designed to maintain data for a duration of time after a power loss or shut down operation. In certain instances, the non-volatile storage devices 608 may be used to store overflow data if allocated RAM is not large enough to hold all working data. The non-volatile storage devices 608 may also be used to store programs, such as programs used to implement one or more GUIs and/or programs used to implement electronic matching for a hearing, that are loaded into the RAM when such programs are selected for execution.

Persons of ordinary skill in the art are aware that software programs, including apps, may be developed, encoded, and compiled in a variety of computing languages for a variety of software platforms and/or operating systems and subsequently loaded and executed by processor 602. In one implementation, the compiling process of the software program may transform program code written in a programming language to another computer language such that the processor 602 is able to execute the programming code. After the compiling process, the encoded instructions may then be loaded as computer executable instructions or process steps to processor 602 from storage device 608, from memory 604, and/or embedded within processor 602 (e.g., via a cache or on-board ROM). In some cases, software may be stored persistently on a storage device as firmware. Processor 602 may be configured to execute the stored instructions or process steps in order to perform instructions or process steps to transform the computing device into a non-generic, particular, specially programmed machine or apparatus. Stored data, e.g., data stored by a storage device 608, may be accessed by processor 602 during the execution of computer executable instructions or process steps to instruct one or more components within the computing device 600.

Computing device 600 further includes sensors 612. Sensors 612 may include a location device used to determine the location of the computing device 600. For example, the location device may include a satellite-based location device, such as a GPS chip having a GPS receiver, a processor, and a memory that may be to determine the location of the computing device 600 based on geolocation and/or time information provided by a global navigation satellite system. Additionally, sensors 612 may include other types of sensors such as, but not limited to, thermal (heat, cold, or change in temperature) sensors, motion sensors, proximity monitors, light sensors, and different combinations thereof, which may monitor for a change in condition or environmental metric and report on what has been detected (i.e., sensed).

In cases where a sensor 612 performs a processing function, some or all of the components illustrated in FIG. 6 (e.g., processor 602, memory 604, storage 608, communication devices 610) may be used by or separately included within that sensor. For example, one or more sensors 612 may include one or more sensor processors that may be similar to a digital processor. One or more sensors 612 may include internal memory for storing processing instructions or configuration parameters. The sensor processor may provide an output signal to indicate information detected or obtained (e.g., via processing) at that sensor 612. The output signal may be provided to a receiving processor (e.g., a processor of a remote computing device such as a server device). The output signal may be transmitted via a wired or wireless connection. The connection may, in some cases, be a network connection such as a computer network or a component device network. The sensor processor of one or more sensors 612 may also receive input information from active sensing components (e.g., components measuring environmental factors) of different types of sensors 612.

While the embodiments are described with reference to various implementations and exploitations, it will be understood that these embodiments are illustrative and that the scope of the inventive subject matter is not limited to specifically disclosed implementations. Many variations, modifications, additions and improvements are possible.

Plural instances may be provided for components, operations, or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

Insofar as the description above and the accompanying drawings disclose any additional subject matter that is not within the scope of the claim(s) herein, the inventions are not dedicated to the public and the right to file one or more applications to claim such additional invention is reserved. Although a very narrow claim may be presented herein, it should be recognized the scope of this invention is much broader than presented by the claim(s). Broader claims may be submitted in an application that claims the benefit of priority from this application.

Certain terms have been used throughout this description and claims to refer to particular system components. As one skilled in the art will appreciate, different parties may refer to a component by different names. This document does not intend to distinguish between components that differ in name but not function. In this disclosure and claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first component couples to a second component, that coupling may be through a direct connection or through an indirect connection via other components and connections. In this disclosure a direct connection will be referenced as a “connection” rather than a coupling. The recitation “based on” is intended to mean “based at least in part on.” Therefore, if X is based on Y, X may be a function of Y and any number of other factors.

The above discussion is meant to be illustrative of the principles and various implementations of the present disclosure. Numerous variations and modifications will become apparent to those skilled in the art once the above disclosure is fully appreciated. It is intended that the following claims be interpreted to embrace all such variations and modifications.

1. A computer-implemented method comprising:
obtaining, at a requesting computing device, a request message for an attorney to cover a hearing, the request message including both a plurality of availability requirements and a plurality of qualification requirements, the availability requirements including a date, a location, and a time of the hearing, the qualification requirements including an indication of attorney qualifications to satisfy a set of legal requirements of the hearing;
identifying a set of potential attorneys from which to request covering the hearing;
transmitting the request message to one or more remote computing devices, each of the remote computing devices associated with a respective potential attorney from the set of potential attorneys, the request message to solicit interest in covering the hearing;
receiving, at a matching computing device, one or more response messages from a subset of the one or more remote computing devices, each of the one or more response messages
responsive to the request message and including:
an indication of an availability of an attorney of interest; and
a match request for the hearing,
wherein the set of one or more response messages indicates a set of interested attorneys;
comparing, at the matching computing device, attorney qualifications for each attorney of interest from the set of interested attorneys against the qualification requirements;
determining, at the matching computing device, if the indication of the availability of each attorney of interest from the set of interested attorneys matches the plurality of availability requirements;
determining, at the matching computing device, for each attorney of interest from the set of interested attorneys whether the respective attorney first is associated with attorney qualifications satisfying the legal requirements of the hearing; and
selecting a first attorney of interest from the set of interested attorneys, the first attorney of interest satisfying each of the qualification requirements, the legal requirements, and the availability requirements.

2. The computer-implemented method of claim 1, further comprising:
receiving, at the requesting computing device, an indication that a selection of the first attorney of interest to cover the hearing has been completed; and
notifying one of the set of one or more remote computing devices that is associated with the selected first attorney of interest of the selection.

3. The computer-implemented method of claim 1, wherein the availability of the attorneys associated with the one or more remote computing devices is obtained before transmitting the request message to the one or more remote computing devices.

4. The computer-implemented method of claim 3, wherein obtaining the availability of the attorneys associated with the one or more remote computing devices comprises receiving an indication of a plurality of respective real-time locations of the attorneys associated with the one or more remote computing devices on the date and before the time of the hearing.

5. The computer-implemented method of claim 3, further comprising:
synchronizing with an electronic calendar to obtain the availability of the attorneys associated with the one or more remote computing devices.

6. The computer-implemented method of claim 1, wherein the indication of the availability is received after transmitting the request message to the remote computing device.

7. The computer-implemented method of claim 6, wherein the requesting computing device and the matching computing device are a single computing device.

8. The computer-implemented method of claim 1, wherein comparing the attorney qualifications for each individual attorney of interest from the set of interested attorneys against the qualification requirements comprises retrieving the attorney qualifications for each individual attorney of interest from a database.

9. The computer-implemented method of claim 1, wherein comparing the attorney qualifications for each individual attorney of interest from the set of interested attorneys against the qualification requirements comprises receiving the attorney qualifications for at least one individual attorney of interest from a respective remote computing device associated with the at least one individual attorney of interest.

10. The computer-implemented method of claim 1, further comprising:
connecting with an electronic court docketing system; and
replacing an existing attorney for the hearing with the selected first attorney of interest, within the electronic court docketing system.

11. A non-transitory machine-readable storage medium including executable instructions that, when executed by a processor of a first computing device, cause the processor to:
receive, through a graphical user interface executing on the first computing device, a request for an attorney to cover a hearing, the request used to formulate a request message comprising:
a plurality of availability requirements including a date, a location, and a time of the hearing; and
a plurality of attorney qualifications to cover the hearing;
transmit the request message from the first computing device to a second computing device, the request message intended for at least a first remote device and a second remote device, each of the first remote device and the second remote device associated with a respective potential attorney to cover the hearing;
obtain a first response to the request message, the first response identifying a first attorney of interest having a first availability that meets the availability requirements and a first set of qualifications that satisfy the attorney qualifications, the first response initiated from the first remote device associated with the first attorney of interest;
obtain a second response to the request message, the second response identifying a second attorney of interest having a second availability that meets the availability requirements and a second set of qualifications that satisfy the attorney qualifications, the second response initiated from the second remote device associated with the second attorney of interest;
present, using the graphical user interface on the first computing device, an identity of the respective attorneys of interest providing a response;
receive, using the graphical user interface on the first computing device, a selection indicating one of the identified attorneys as a selected attorney; and
store an indication of the selected attorney at the second computing device.

12. The non-transitory machine-readable storage medium of claim 11, further comprises a third response, wherein the third response to the request message further identifies a third attorney of interest having a third availability that meets the availability requirements and a third set of qualifications that satisfy the attorney qualifications, and wherein the executable instructions, when executed by the processor, further cause the processor to:
present, using the graphical user interface of the first computing device, the third attorney as one of the identities of respective attorneys of interest for the selection.

13. The non-transitory machine-readable storage medium of claim 11, wherein the executable instructions, when executed by the processor, further cause the processor to confirm, by exchanging communications with a remote computing device associated with the selected attorney, the selection of the selected attorney.

14. A computing device associated with a first attorney of interest, the computing device comprising:
a processor;
a location device to determine a real-time location of the computing device; and
a non-transitory machine-readable storage medium including executable instructions that, when executed by the processor, cause the processor to:
receive, from a remote computing device, a request for an attorney to cover a hearing, the request comprising a request message including:
a set of availability requirements including a date, a location, and a time of the hearing; and
a set of attorney qualifications to cover the hearing;
present, using a graphical user interface of the computing device, a set of information extracted from the request message pertaining to the request;
receive, using the graphical user interface, a selection of the request; and
transmit a response message, in response to the request message, to the remote computing device, the response message including:
an indication of an availability and the real-time location of the computing device first; and
a match request for the hearing.

15. The computing device of claim 14, wherein a set of availability information for the first attorney of interest is obtained before receiving the request message.

16. (canceled)

17. The computing device of claim 15, wherein the instructions further cause the processor to synchronize with an electronic calendar to obtain the indication of the availability.

18. The computing device of claim 14, wherein the indication of the availability is obtained after receiving the request message.

19. The computing device of claim 18, wherein the match request provides the indication of availability.

20. The computing device of claim 14, wherein the instructions further cause the processor to provide, as a portion of the response message, a set of qualifications for the first attorney of interest.
